(19) United States
(12) Patent Application Publication
(10) Pub. No.: US 2026/0350043 A1
(43) Pub. Date: Nov. 5, 2026

(54) SOCIAL COMMUNITY-DRIVEN PROMPT AUGMENTATION

(71) Applicant: MICROSOFT TECHNOLOGY LICENSING, LLC, Redmond, WA (US)

(72) Inventors: Ion TODIREL, Bellevue, WA (US); Bogdan Ionut MIHALCEA, Sammamish, WA (US)

(21) Appl. No.: 19/195,397

(22) Filed: Apr. 30, 2025

(51) Int. Cl. G06F 16/31; G06F 8/35

(52) U.S. Cl. CPC G06F 16/313; G06F 8/35

(57) ABSTRACT

Systems and methods are provided for processing and augmenting prompts based on indexed prompts that are determined to be contextually relevant and successful. The systems and methods also include indexing prompts and updating the indexed prompts based on context and success information associated with the prompts. In some instances, the success information is based on user input responsive to model responses corresponding to the prompts.

### BACKGROUND

In software development, autocompletion and auto-suggestion tools play a crucial role in enhancing productivity and reducing the cognitive load on developers. These tools are commonly integrated into modern integrated development environments (IDEs) and provide real-time code suggestions based on the context of the code being written.

Many autocompletion tools utilize machine learning models trained to process initial inputs, such as text characters or code segments, to predict subsequent completions or modifications. These models are trained on datasets containing complete words and code samples. To support various programming languages, the models are often trained on extensive code repositories to learn the patterns and structures of different languages. Typical machine learning models employ a self-attention mechanism to understand the context of the initial inputs and make accurate predictions for subsequent content. The initial inputs are provided to the machine learning models as prompts, and the predicted content is returned as responses. The model responses are processed by the IDE to present the predicted content as autocomplete suggestions.

In some use scenarios, developers can also draft or ‘engineer’ prompts in the form of questions or queries, either within or even outside of an IDE, and without necessarily invoking autocompletion tools. In such instances, the engineered prompts are provided to one or more machine learning models trained to generate corresponding responses.

Notably, existing models have be trained on different knowledgebases and are configured to utilize different algorithms and weighting mechanisms, each processing prompts in unique ways based on the context and attention given to different elements of the prompts that they process.

The variability in existing model structures and processing capabilities creates significant challenges in prompt engineering, making it difficult to effectively utilize the machine learning models, as the same prompts can often yield different responses depending on the contexts of the prompts and depending on which models are processing the prompts.

In view of the foregoing, it will be appreciated that effective prompt engineering requires a deep understanding of how to create prompts that elicit the desired suggestions from the models. However, even with a deep understanding of how to create a prompt, developers often need to engage with the models through an iterative process involving multiple prompts, responses, and follow-up prompts until a useful response is obtained. This iterative prompt-response conversation process can be time-consuming and represents a waste of computational and user resources.

Given these challenges, there is an ongoing need and desired for improved systems and methods for addressing the challenges associated with prompt engineering.

The subject matter claimed herein is not limited to embodiments that solve any disadvantages or that operate only in environments such as those described above. Rather, this background is only provided to illustrate one example technology area where some embodiments described herein may be practiced.

### SUMMARY OF THE INVENTION

Systems and methods are provided for facilitating prompt processing and, even more particularly, for facilitating prompt creation and augmentation.

In some aspects, the techniques described herein relate to a method for facilitating prompt processing and augmentation, the method including: identifying a new prompt for one or more machine learning model; prior to transmitting the prompt to the one or more machine learning model, generating an augmented new prompt by augmenting the prompt with content from one or more selected prompts selected from a prompt index, the one or more selected prompts being top-n ranked prompt(s) selected from the prompt index based on a determined success of the one or more selected prompts for a matching context of the one or more selected prompts to a context of the new prompt, such that the top-n ranked prompt(s) having a relatively higher determined success for the matching context will be selected while other prompts with relatively lower determined successes for the matching context will not be selected; transmitting the augmented new prompt to the one or more machine learning model; obtaining a corresponding model response to the augmented new prompt; and identifying user input responsive to the model response and triggering a modification to the determined success and/or ranking of the one or more selected prompts in the prompt index based on the user input responsive to the model response for the augmented new prompt.

In some aspects, the techniques described herein relate to a method for facilitating prompt processing and augmentation, the method including: identifying a plurality of prompts processed by one or more machine learning model and corresponding model responses generated for the prompts from the one or more machine learning model; determining success of the prompts based on user inputs responsive to the responses; classifying and ranking the prompts based on the determined success as well as a context associated with each of the prompts; storing the classified prompts in a prompt index; identifying a new prompt and context of the new prompt; prior to the new prompt being transmitted to the one or more machine learning model, triggering the generation of an augmented new prompt with content from one or more selected prompts selected from the prompt index, the one or more selected prompts being top-n ranked prompt(s) selected from the prompt index based on the determined success of the one or more selected prompts for a matching context of the one or more selected prompts to the context of the new prompt, such that the top-n ranked prompt(s) having a relatively higher determined success for the matching context will be selected while other prompts with relatively lower determined successes for the matching context will not be selected; identifying the augmented new prompt that is transmitted to the one or more machine learning model as well as user input responsive to a model response for the augmented new prompt; and modifying the determined success and/or ranking of the one or more selected prompts in the prompt index based on the user input responsive to the model response for the augmented new prompt.

In some aspects, the techniques described herein relate to a computing system including: one or more hardware processor; and one or more hardware storage device having stored computer-executable instructions that are executable by the one or more hardware processor to cause the computing system to implement a method for facilitating prompt processing and augmentation, the method including: identifying a plurality of prompts processed by one or more machine learning model and corresponding model responses generated for the prompts from the one or more machine learning model; determining success of the prompts based on user inputs responsive to the responses; classifying and ranking the prompts based on the determined success as well as a context associated with each of the prompts; storing the classified prompts in a prompt index; identifying a new prompt and context of the new prompt; prior to the new prompt being transmitted to the one or more machine learning model, causing the generation of an augmented new prompt with content from one or more selected prompts selected from the prompt index, the one or more selected prompts being top-n ranked prompt(s) selected from the prompt index based on the determined success of the one or more selected prompts for a matching context of the one or more selected prompts to the context of the new prompt, such that the top-n ranked prompt(s) having a relatively higher determined success for the matching context will be selected while other prompts with relatively lower determined successes for the matching context will not be selected; causing the augmented new prompt to be transmitted to the one or more machine learning model; obtaining a corresponding model response to the augmented new prompt; and modifying the determined success and/or ranking of the one or more selected prompts in the prompt index based on user input responsive to the model response for the augmented new prompt.

In some aspects, the techniques described herein relate to a method, wherein the user input responsive to the model response includes user input for accepting or copying at least a portion of the model response and wherein said modifying includes increasing the determined success and/or ranking of the one or more selected prompts.

In some aspects, the techniques described herein relate to a method, wherein the user input responsive to the model response includes user input for rejecting at least a portion of the model response or for responding to the model response with a follow-up prompt and wherein said modifying includes decreasing the determined success and/or ranking of the one or more selected prompts.

In some aspects, computing systems are configured with one or more hardware processors and stored computer-executable instructions that are executable by the one or more processors to implement the disclosed methods.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

In order to describe the manner in which the advantages and features of the systems and methods described herein can be obtained, a more particular description of the embodiments briefly described above will be rendered by reference to specific embodiments thereof which are illustrated in the appended drawings. Understanding that these drawings depict only typical embodiments of the systems and methods described herein, and are not therefore to be considered to be limiting of their scope, certain systems and methods will be described and explained with additional specificity and detail through the use of the accompanying drawings in which:

FIG. 1 illustrates a computing environment that may be utilized to implement the disclosed embodiments for facilitating prompt processing, including prompt creation and augmentation.

FIG. 2 illustrates a flowchart of acts associated with methods for facilitating prompt processing, including prompt creation and augmentation.

FIG. 3 illustrates another flowchart of acts associated with methods for facilitating prompt processing, including prompt creation and augmentation.

FIG. 4 illustrates an example of a prompt index with a ranked set of indexed prompts and a processing flow for updating the prompt index, including the re-ranking of the indexed prompts, based on context and user input associated with different prompts.

FIGS. 5-6 illustrates example processing flows for facilitating prompt processing, including prompt creation and augmentation.

### DETAILED DESCRIPTION OF THE INVENTION

As previously noted, the disclosed embodiments are generally directed to systems and methods for facilitating prompt processing and, even more particularly, for facilitating prompt creation and augmentation.

Beneficially, the disclosed embodiments augment prompts based on relevant indexed prompts and the prior success of the indexed prompts for related contexts in which they were used. In this manner, it is possible to refine the prompts that are created, prior to being processed by the machine learning models, such that the responses to the modified prompts are more likely to be useful for the given context in which they were created. In this manner it is possible to greatly reduce the iterations of prompting required for a user to obtain a desired and useful response. This will become even more apparent from the additional disclosure provided herein.

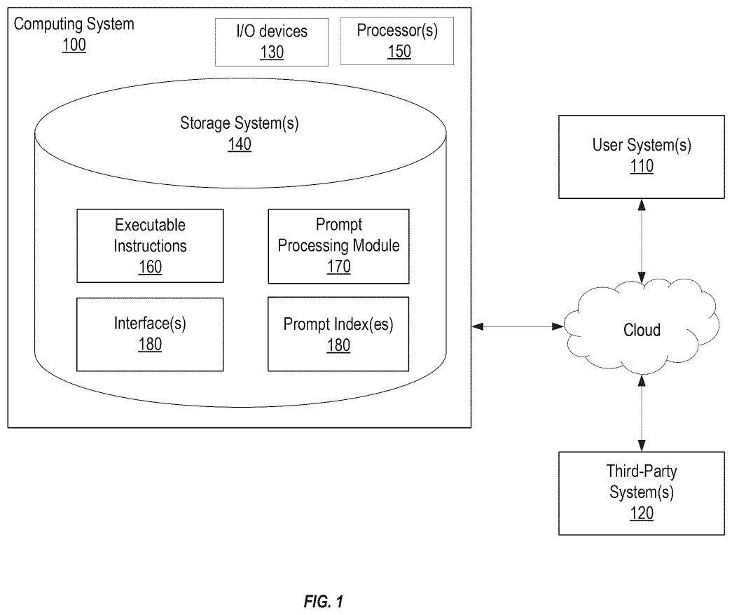

Attention is now directed to FIG. 1, which illustrates a computing system that can comprise and/or be utilized to facilitate the embodiments described herein. As shown, the computing system 100 is in communication with one or more user system(s) 110 and/or third-party system(s) 120. In some implementations, the user system(s) 110 and third-party system(s) 120 are remotely located from the computing system 100 and are independently controlled computing systems. In other implementations, the user system(s) 110 and/or third-party system(s) 120 comprise distributed components of the computing system 100, such that they share storage and processing capabilities.

Computing system 100 is connected to the other user system(s) 110 and third-party system(s) 120 through a network of wired and/or wireless connections, such as currently represented as the cloud.

Each of the illustrated systems includes input and output devices (I/O devices 130) for receiving inputs and rendering outputs, respectively, even though they are only explicitly shown for computing system 100. Non-limiting examples of input devices include microphones, keyboards, mouse devices, touch pads, and camera sensors. Non-limiting examples of output devices include speakers, desktop display screens, mixed-reality display devices, and haptic feedback devices.

The disclosed systems also include one or more storage system(s) 140 of volatile and/or non-volatile storage and one or more hardware processor(s) 150 configured to execute computer-executable instructions 160 stored in the storage system(s) 140 to cause the computing system 100 to implement the methods and functionality disclosed herein.

The storage system(s) 140 also store interfaces 180 in which the code is being developed and/or in which a user can interact with the disclosed models that are capable of processing user prompts. An integrated development environment (IDE) is an exemplary interface. In some instances, a browser to the internet can also comprise an exemplary interface. Application interfaces are also exemplary interfaces.

In some instances, storage system(s) also store a prompt processing module configured to identify the context in which a prompt is generated and to index the prompt in a prompt index 180 with corresponding context information and success information of the prompt.

The prompt context information can include, for example, metadata or datafiles that identify information about a codebase being developed in an application where/when the prompt is created, as well as the developer who provided the input for creating the prompt. In this regard, context can include user context information (e.g., information about a particular user or entity associated with the development or use of code), task and application context (e.g., a function or manner of utilizing code in an application or the type of application being used and functionality invoked in the application), historical use data (e.g., how code has been used in other applications), location or device context (e.g., systems and enterprises being utilized), codebase contexts (e.g., specific programming language and the types of classes, functions, and declarations used in the code, as well as dependencies and specific parts of a codebase that will be affected or modified during a development process), temporal context (e.g., past, present, and future use), and social or enterprise contexts (e.g., user or group assignment, privileges, confidentiality).

The success information, as described in more detail below, can comprise a determined success in which the processing of a prompt resulted in a successful response, wherein a successful response is determined to be a response in which at least a portion of the response is copied or otherwise accepted by a user, and wherein an unsuccessful response is determined to be a model response in which at least a portion of the response or all of the response contains content that is rejected by the user (e.g., the user does not accept or utilize the content in the response and/or creates a new reply prompt responsive to the model response).

The prompt processing module 170 is configured to rank the different prompts in the prompt index 180 based on their success, wherein the success is based at least in part on detected user input that is responsive to the model response. The prompt processing module 170 can modify a ranking of a prompt in the prompt index 180 and the corresponding success information for the different prompts in the index based on detected user input that is responsive to or that otherwise corresponds to a model's response for the associated prompt.

For example, in some instances, the user input responsive to a model response for an associated prompt includes user input for accepting or copying at least a portion of the model response. In this instance, the prompt processing module 170 can modify the indexed prompt ranking of the associated prompt by increasing the determined success and/or ranking of the associated prompt. Likewise, in some instances, the user input responsive to a model response for an associated prompt includes user input for rejecting at least a portion of the model response or for responding to the model response with a follow-up prompt. In these instances, the prompt processing module 170 can modify the indexed prompt ranking of the associated prompt by decreasing the determined success and/or ranking of the one or more selected prompts.

The prompt processing module is also configured to rank the different prompts in the prompt index 180, in some instances, based on the success of the indexed prompts in combination with or according to different contexts. For example, the prompts in the prompt index 180 can be ranked according to different types of contexts (e.g., different models used to process the prompts, different programming languages associated with code referenced in the prompt, different developers, different lines of code and/or different functions within a program being developed and referenced by the prompt, etc.), as well as based on the user input responsive to the response. In this regard, the prompt index 180 may comprise many sub-indexes that each correspond to a different set of one or more contexts and that each rank different prompts associated with the grouping context(s) based on relative success/failure of the prompts for obtaining content that is useful (as determined by user input responsive to the response content).

Although not explicitly shown, other data used to implement the functionality described herein can be stored within the storage system(s) 140, such as, but not limited to the machine learning models that process the prompts. Although, in preferred embodiments, the machine learning models are hosted by remote services and systems.

The referenced machine learning models can comprise a large language model (LLM), or any type of machine learning model that is configured to generate responses with content corresponding to prompts that are processed by the machine learning model. LLMs and other machine learning models of the referenced types are well-known to those of skill in the art. Notably, the scope of the claimed invention is not limited to any particular type of machine learning model. Instead, the scope of the claimed invention is directed to the processing of prompts, including the creation and augmenting of prompts that are processed by the machine learning models.

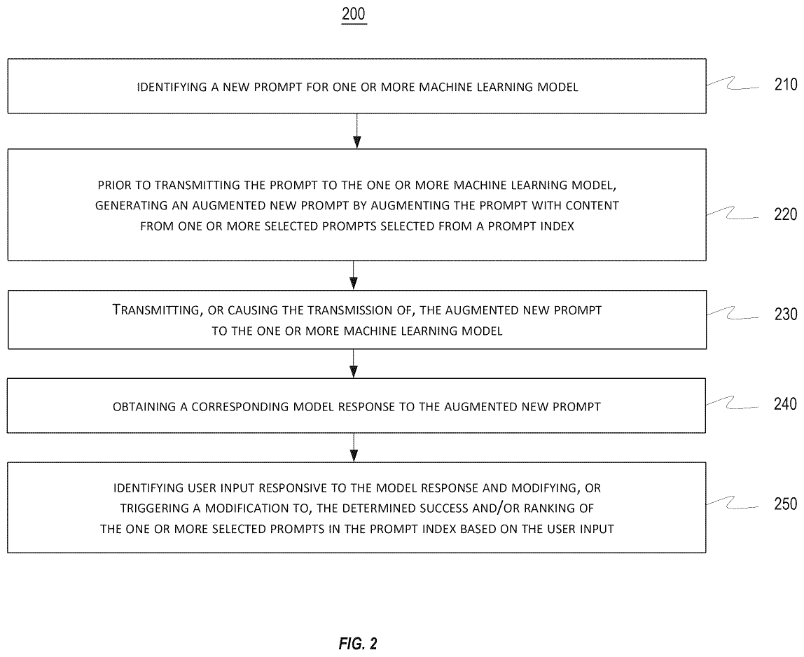

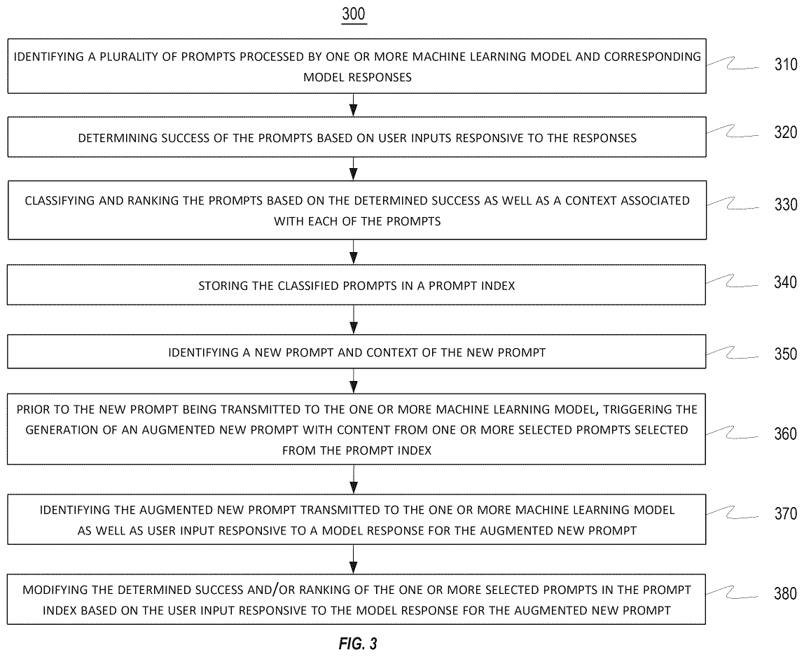

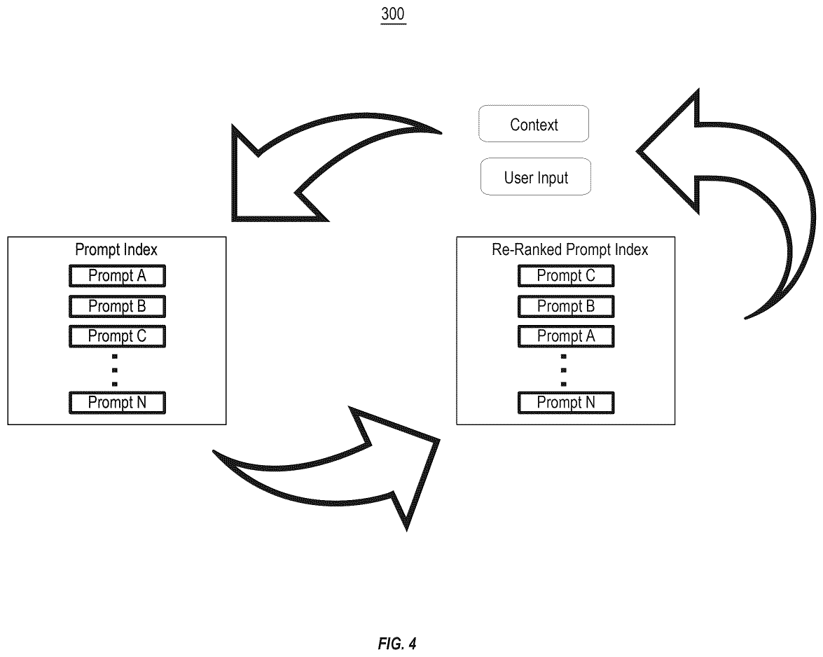

It will be appreciated that computing system 100 can be utilized to implement the disclosed methods, including the methods associated with the acts that are illustrated in the flowcharts of FIGS. 2-3 and the processing flows illustrated in FIGS. 4-6, as described in more detail below.

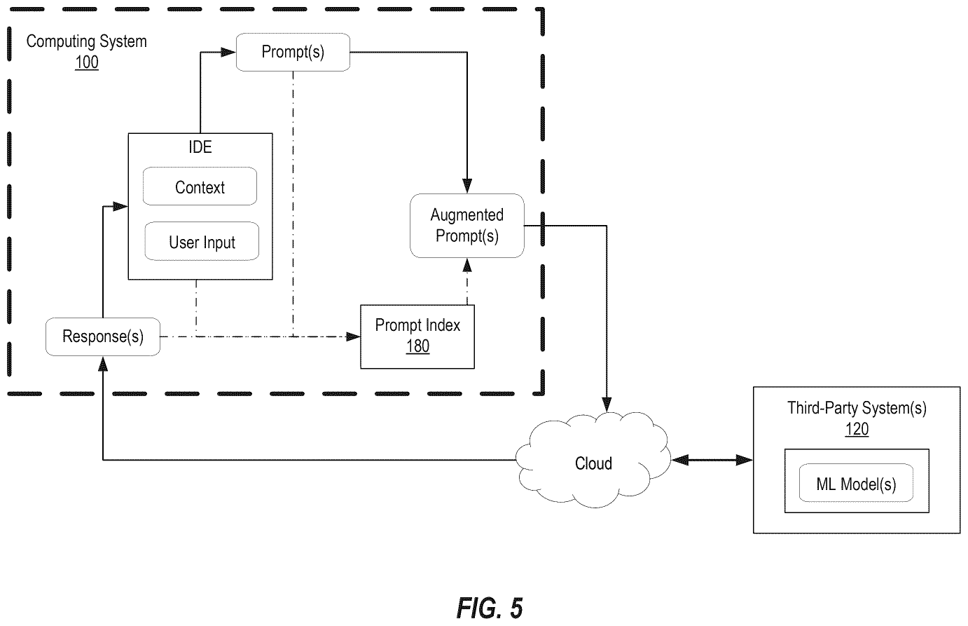

As shown by the flowchart 200 of FIG. 2, and the processing flow illustrated in FIG. 5, the acts implemented by the disclosed methods for facilitating processing and augmenting of prompts include identifying a new prompt for one or more machine learning model (act 210). This may include, for instance, detecting user input in an IDE sufficient to trigger an autocompletion functionality and in which the user entered text characters and/or code adjacent the user input is entered into a prompt. This may also include a user entering a prompt into a prompt field that is presented automatically to a user and/or in response to a user entering a command or selecting a control element associated with the prompt field. The user entered prompt can include text typed or copied into the prompt field by the user in the form of a complete (or partial) query, statement, a segment of code, file or other input.

Flowchart 200 also include an act of, prior to transmitting the prompt to the one or more machine learning model, generating an augmented new prompt by augmenting the prompt with content from one or more selected prompts selected from a prompt index (act 220).

In some instances, the one or more selected prompts is/are top-n ranked prompt(s) selected from the prompt index based on a determined success of the one or more selected prompts for a matching context of the one or more selected prompts to a context of the new prompt, such that the top-n ranked prompt(s) having a relatively higher determined success for the matching context will be selected while other prompts with relatively lower determined successes for the matching context will not be selected.

Next, act 230 includes transmitting the augmented new prompt to the one or more machine learning model that will process the augmented new prompt.

Then, a corresponding model response is obtained to the augmented new prompt (act 240). Finally, user input responsive to the model response is identified and used to trigger a modification to the determined success and/or ranking of the one or more selected prompts in the prompt index based on the user input responsive to the model response for the augmented new prompt (act 250).

As noted earlier, the act of identifying user input responsive to the model response can comprise detecting user input for copying and/or otherwise accepting at least a portion of the model response, wherein said user input will result in the determined success and/or ranking of the one or more selected prompts used in the generation of the augmented new prompt to be increased within the prompt index.

In other instances, the act of identifying user input responsive to the model response comprises detecting user input for rejecting at least a portion of the model response, wherein said user input will result in the determined success and/or ranking of the one or more selected prompts used in the generation of the augmented new prompt to be decreased within the prompt index. The input for rejecting a response can include a follow-up prompt created by the user without the user accepting a portion of the received response.

The user input used for evaluating the success/failure of a prompt can also be input such as a user selecting an evaluation feature displayed with the response (e.g., a user selecting a thumbs-up feature displayed with the response will indicate a success of the prompt and will trigger an upgrading of the success information and/or rank of the prompt in the prompt index, whereas a user selecting a thumbs-down feature displayed with the response will indicate a success of the prompt and will trigger an upgrading of the success information and/or rank of the prompt in the prompt index).

In some instances, the act of triggering the modification to the index (act 250), can include transmitting the user input to a remote computing system that manages the prompt index. In other instances, the local system that receives the user input manages and modifies the prompt index without having to transmit the user input to a remote system to trigger modification of the prompt index.

In some instances, the generation and transmission of the augmented new prompt is performed without displaying the augmented new prompt to a user or at the system where the prompt is created. This can be beneficial to hide the augmented prompt from the user, particularly when the augmented prompt contains trade secret prompt engineering information extracted from successfully stored and indexed prompts.

In other instances, the generation of the augmented new prompt includes displaying the augmented new prompt to a user prior to transmitting the augmented new prompt to the one or more machine learning model. This can be beneficial for enabling a user to review and accept and/or further modify the proposed changes to the original prompt prior to submitting the augmented prompt for processing. This can be particularly beneficial for facilitating the education and training of the user in the techniques of engineering successful prompts.

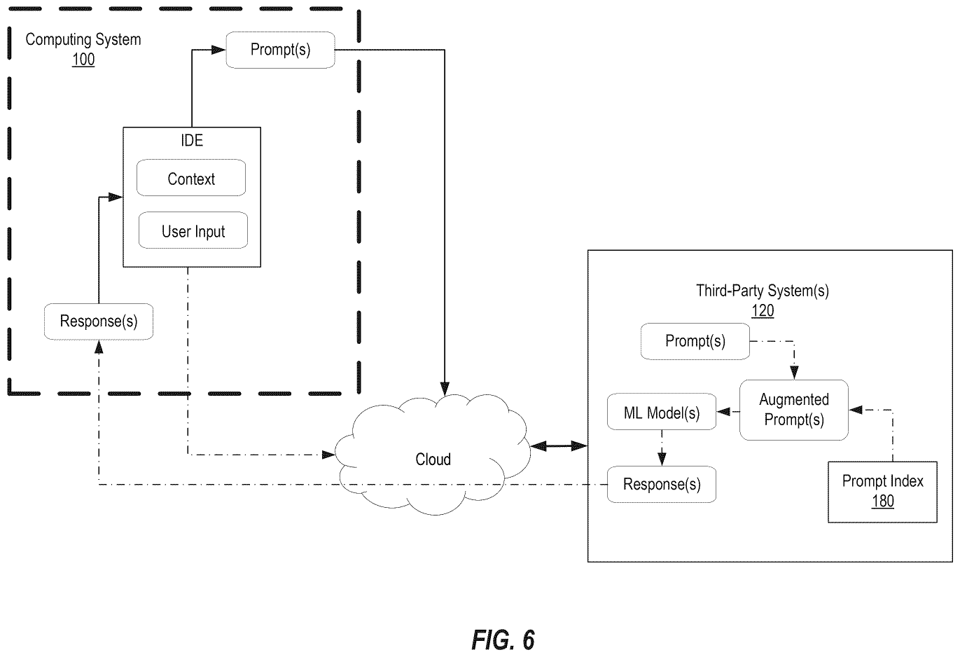

FIG. 3 illustrates a related flowchart 300, with similar acts to those that are illustrated in flowchart 200 of FIG. 2. However, there are some differences in the recited acts to reflect the difference in perspective and location for the system that manages the prompt index. In particular, flowchart 200 corresponds directly to the computing environment configuration and processing flow illustrated in FIG. 5, where the prompt index 180 is stored at and managed by computing system 100. In contrast, flowchart 300 of FIG. 3 corresponds to the computing environment configuration and processing flow illustrated in FIG. 6, where the prompt index 180 is stored at and managed by a third-party system 120 remote to computing system 100.

As illustrated in FIG. 3, the illustrated flowchart includes: identifying a plurality of prompts processed by one or more machine learning model and corresponding model responses generated for the prompts from the one or more machine learning model (act 310); determining success of the prompts based on user inputs responsive to the responses (act 320); classifying and ranking the prompts based on the determined success as well as a context associated with each of the prompts (act 330); storing the classified prompts in a prompt index (act 340); identifying a new prompt and context of the new prompt (act 350); prior to the new prompt being transmitted to the one or more machine learning model, triggering the generation of an augmented new prompt with content from one or more selected prompts selected from the prompt index (act 360).

As before, the one or more selected prompts can be the top-n ranked prompt(s) selected from the prompt index based on the determined success of the one or more selected prompts for a matching context of the one or more selected prompts to the context of the new prompt, such that the top-n ranked prompt(s) having a relatively higher determined success for the matching context will be selected while other prompts with relatively lower determined successes for the matching context will not be selected.

The augmented new prompt transmitted to the one or more machine learning model is then identified, as well as the user input responsive to a model response for the augmented new prompt (act 370). And then, finally, the determined success and/or ranking of the one or more selected prompts in the prompt index is modified based on the user input responsive to the model response for the augmented new prompt (act 380).

The processing flow of these acts is illustrated in FIG. 6.

For this processing flow, as also occurs in FIG. 2 and FIG. 5, when the user input responsive to the model response includes user input for accepting or copying at least a portion of the model response, the referenced modifying of the prompt index includes increasing the determined success and/or ranking of the one or more selected prompts. Likewise, when the user input responsive to the model response includes user input for rejecting at least a portion of the model response or for responding to the model response with a follow-up prompt, the referenced modifying includes decreasing the determined success and/or ranking of the one or more selected prompts.

Despite the specificity of the foregoing embodiments, particularly with regard to the location of the prompt index 180, it will be appreciated that these embodiments are not mutually exclusive. Instead, some embodiments contemplate a combination of the foregoing embodiments.

By way of example, some disclosed embodiments include a host server system (not shown) that includes all or a portion of computing system 100, as well as third-party system 120. In such a configuration, the disclosed methods can include the host system identifying a plurality of prompts processed by one or more machine learning model and corresponding model responses generated for the prompts from the one or more machine learning model; determining success of the prompts based on user inputs responsive to the responses; classifying and ranking the prompts based on the determined success as well as a context associated with each of the prompts; storing the classified prompts in a prompt index; identifying a new prompt and context of the new prompt; prior to the new prompt being transmitted to the one or more machine learning model, causing the generation of an augmented new prompt with content from one or more selected prompts selected from the prompt index, the one or more selected prompts being top-n ranked prompt(s) selected from the prompt index based on the determined success of the one or more selected prompts for a matching context of the one or more selected prompts to the context of the new prompt, such that the top-n ranked prompt(s) having a relatively higher determined success for the matching context will be selected while other prompts with relatively lower determined successes for the matching context will not be selected; causing the augmented new prompt to be transmitted to the one or more machine learning model; obtaining a corresponding model response to the augmented new prompt; and modifying the determined success and/or ranking of the one or more selected prompts in the prompt index based on user input responsive to the model response for the augmented new prompt.

Attention is now directed to FIG. 4, which illustrates an example of a prompt index with ranked prompts and the processing of user inputs and context to affect the re-ranking of the prompts in a re-ranked prompt index.

Each of the indexed prompts includes the actual prompt text/file(s) that are included in the prompt, as well as the context information and/or success information for each of the prompts. The prompts can be added to the prompt index when the prompts are created, before responses are received (in which case the success information may be default or null values), or after the corresponding model responses are received for the prompts and after the corresponding success information is determined for the prompts based on the user input responsive to the model response(s).

Regardless of when the prompts are indexed, they can be updated with new success information based on detected user input(s) received responsive to the model responses that are received for the associated prompts and/or based on new context information that corresponds to processing of the prompts. As the indexed prompts are updated with new success information and/or context information, they can be re-ranked according to their relative success for different contexts.

Then, when the prompt index is referenced for augmenting new prompts of the same or relevant contexts, the top-N prompts (1, 2, 3, or more than 3 prompts) in the index having the matching context(s) can be selected to augment the new prompts. The augmenting of the new prompts based on indexed prompts, can include replacing portions of the new prompt (e.g., modifying or deleting a portion of the new prompt with content from the indexed prompt(s)) or simply supplementing the new prompt with content from the indexed prompt(s).

By augmenting the new prompt with content from the indexed prompt(s) having matching context(s) that are determined to have been successful, it is possible to increase the likely success of the new prompt. The benefits of this can include reducing the prompting iterations that might otherwise be needed to obtain a response with content that is useful. This is particularly beneficial for sharing and leveraging communities of prompt engineering user experiences. In particular, the prompt index(s) used to augment new prompts can include and be updated based on prompts from disparate entities and social networks.

As noted earlier, the disclosed methods and functionality may be performed by computing system 100, which may take various different forms and which may include and/or be in communication with one or more user systems and third-party system.

For example, computing system 100 may be embodied as a tablet, a desktop, a laptop, a mobile device, or a standalone device, such as those described throughout this disclosure. Computing system 100 may also be a distributed system that includes one or more connected computing components/devices that are in communication with computing system 100.

In its most basic configuration, computing system 100 includes various different components, such as the referenced processors. Without limitation, illustrative types of hardware logic components/processors that can be used include Field-Programmable Gate Arrays (“FPGA”), Program-Specific or Application-Specific Integrated Circuits (“ASIC”), Program-Specific Standard Products (“ASSP”), System-On-A-Chip Systems (“SOC”), Complex Programmable Logic Devices (“CPLD”), Central Processing Units (“CPU”), Graphical Processing Units (“GPU”), or any other type of programmable hardware.

As used herein, the terms “executable module,” “executable component,” “component,” “module,” “service,” or “engine” can refer to hardware processing units or to software objects, routines, or methods that may be executed on computing system 100. The different components, modules, engines, and services described herein may be implemented as objects or processors that execute on computing system 100 (e.g. as separate threads).

The referenced storage system(s) may be physical system memory, which may be volatile, non-volatile, or some combination of the two. The term “memory” may also be used herein to refer to non-volatile mass storage such as physical storage media. If computing system 100 is distributed, the processing, memory, and/or storage capability may be distributed as well.

The storage system(s) may include physical and other computer-readable media for carrying or storing computer-executable instructions and/or data structures. Such computer-readable media can be any available media that can be accessed by a general-purpose or special-purpose computer system. Computer-readable media that store computer-executable instructions in the form of data are “physical computer storage media” or a “hardware storage device.” Furthermore, computer-readable storage media, which includes physical computer storage media and hardware storage devices, exclude signals, carrier waves, and propagating signals. On the other hand, computer-readable media that carry computer-executable instructions are “transmission media” and include signals, carrier waves, and propagating signals. Thus, by way of example and not limitation, the current embodiments can comprise at least two distinctly different kinds of computer-readable media: computer storage media and transmission media.

Computer storage media (aka “hardware storage device”) are computer-readable hardware storage devices, such as RAM, ROM, EEPROM, CD-ROM, solid state drives (“SSD”) that are based on RAM, Flash memory, phase-change memory (“PCM”), or other types of memory, or other optical disk storage, magnetic disk storage or other magnetic storage devices, or any other medium that can be used to store desired program code means in the form of computer-executable instructions, data, or data structures and that can be accessed by a general-purpose or special-purpose computer.

Computer system 100 may also be connected (via a wired or wireless connection) to external sensors (e.g., one or more remote cameras) or devices via a network defined as one or more data links and/or data switches that enable the transport of electronic data between computer systems, modules, and/or other electronic devices. For example, computer system 100 can communicate with any number of devices or cloud services to obtain or process data. In some cases, the network may itself be a cloud network (e.g., the cloud shown in FIG. 1). Furthermore, computer system 100 may also be connected through one or more wired or wireless networks to remote/separate computer systems(s) that are configured to perform any of the processing described with regard to computer system 100.

When information is transferred, or provided, over a network (either hardwired, wireless, or a combination of hardwired and wireless) to a computer, the computer properly views the connection as a transmission medium. Computer system 100 will include one or more communication channels that are used to communicate with the network. Transmissions media include a network that can be used to carry data or desired program code means in the form of computer-executable instructions or in the form of data structures. Further, these computer-executable instructions can be accessed by a general-purpose or special-purpose computer. Combinations of the above should also be included within the scope of computer-readable media.

Upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a network interface card or “NIC”) and then eventually transferred to computer system RAM and/or to less volatile computer storage media at a computer system. Thus, it should be understood that computer storage media can be included in computer system components that also (or even primarily) utilize transmission media.

Computer-executable (or computer-interpretable) instructions comprise, for example, instructions that cause a general-purpose computer, special-purpose computer, or special-purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the embodiments may be practiced in network computing environments with many types of computer system configurations, including personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The embodiments may also be practiced in distributed system environments where local and remote computer systems that are linked (either by hardwired data links, wireless data links, or by a combination of hardwired and wireless data links) through a network each perform tasks (e.g. cloud computing, cloud services and the like). In a distributed system environment, program modules may be located in both local and remote memory storage devices.

The present invention may be embodied in other specific forms without departing from its characteristics. The embodiments described are to be considered in all respects only as illustrative and not restrictive. The scope of the invention is, therefore, indicated by the appended claims rather than by the foregoing description. All changes which come within the meaning and range of equivalency of the claims are to be embraced within their scope.

The present invention can also be described in accordance with the following numbered clauses.
Clause 1. A method for facilitating prompt processing and augmentation, the method comprising: identifying a new prompt for one or more machine learning model; prior to transmitting the prompt to the one or more machine learning model, generating an augmented new prompt by augmenting the prompt with content from one or more selected prompts selected from a prompt index, the one or more selected prompts being top-n ranked prompt(s) selected from the prompt index based on a determined success of the one or more selected prompts for a matching context of the one or more selected prompts to a context of the new prompt, such that the top-n ranked prompt(s) having a relatively higher determined success for the matching context will be selected while other prompts with relatively lower determined successes for the matching context will not be selected; transmitting the augmented new prompt to the one or more machine learning model; obtaining a corresponding model response to the augmented new prompt; and identifying user input responsive to the model response and triggering a modification to the determined success and/or ranking of the one or more selected prompts in the prompt index based on the user input responsive to the model response for the augmented new prompt.
Clause 2. The method of clause 1, wherein said identifying user input responsive to the model response comprises detecting user input for copying at least a portion of the model response, and wherein said user input results in the determined success and/or ranking of the one or more selected prompts used in the generation of the augmented new prompt to be increased within the prompt index.
Clause 3. The method of clause 1, wherein said identifying user input responsive to the model response comprises detecting user input for accepting at least a portion of the model response, and wherein said user input results in the determined success and/or ranking of the one or more selected prompts used in the generation of the augmented new prompt to be increased within the prompt index.
Clause 4. The method of clause 1, wherein said identifying user input responsive to the model response comprises detecting user input for rejecting at least a portion of the model response, and wherein said user input results in the determined success and/or ranking of the one or more selected prompts used in the generation of the augmented new prompt to be decreased within the prompt index.
Clause 5. The method of clause 1, wherein said identifying user input responsive to the model response comprises detecting user input for responding to the model response with a follow-up prompt, and wherein said user input results in the determined success and/or ranking of the one or more selected prompts used in the generation of the augmented new prompt to be decreased within the prompt index.
Clause 6. The method of clause 1, wherein triggering said modification comprises transmitting the user input to a remote computing system managing the prompt index.
Clause 7. The method of clause 1, wherein the generation and transmission of the augmented new prompt is performed without displaying the augmented new prompt.
Clause 8. The method of clause 1, wherein the generation of the augmented new prompt includes displaying the augmented new prompt to a user prior to transmitting the augmented new prompt to the one or more machine learning model.
Clause 9. The method of clause 8, wherein the method further includes receiving user input accepting modification of the new prompt to the augmented new prompt prior to transmitting the augmented new prompt to the one or more machine learning model.
Clause 10. A method for facilitating prompt processing and augmentation, the method comprising: identifying a plurality of prompts processed by one or more machine learning model and corresponding model responses generated for the prompts from the one or more machine learning model; determining success of the prompts based on user inputs responsive to the responses; classifying and ranking the prompts based on the determined success as well as a context associated with each of the prompts; storing the classified prompts in a prompt index; identifying a new prompt and context of the new prompt; prior to the new prompt being transmitted to the one or more machine learning model, triggering the generation of an augmented new prompt with content from one or more selected prompts selected from the prompt index, the one or more selected prompts being top-n ranked prompt(s) selected from the prompt index based on the determined success of the one or more selected prompts for a matching context of the one or more selected prompts to the context of the new prompt, such that the top-n ranked prompt(s) having a relatively higher determined success for the matching context will be selected while other prompts with relatively lower determined successes for the matching context will not be selected; identifying the augmented new prompt that is transmitted to the one or more machine learning model as well as user input responsive to a model response for the augmented new prompt; and modifying the determined success and/or ranking of the one or more selected prompts in the prompt index based on the user input responsive to the model response for the augmented new prompt.
Clause 11. The method of clause 10, wherein the user input responsive to the model response comprises user input for copying at least a portion of the model response and wherein said modifying includes increasing the determined success and/or ranking of the one or more selected prompts.
Clause 12. The method of clause 10, wherein the user input responsive to the model response comprises user input for accepting at least a portion of the model response and wherein said modifying includes increasing the determined success and/or ranking of the one or more selected prompts.
Clause 13. The method of clause 10, wherein the user input responsive to the model response comprises user input for rejecting at least a portion of the model response and wherein said modifying includes decreasing the determined success and/or ranking of the one or more selected prompts.
Clause 14. The method of clause 10, wherein the user input responsive to the model response comprises user input for responding to the model response with a follow-up prompt and wherein said modifying includes decreasing the determined success and/or ranking of the one or more selected prompts.
Clause 15. A computing system comprising: one or more hardware processor; and one or more hardware storage device having stored computer-executable instructions that are executable by the one or more hardware processor to cause the computing system to implement a method for facilitating prompt processing and augmentation, the method comprising: identifying a plurality of prompts processed by one or more machine learning model and corresponding model responses generated for the prompts from the one or more machine learning model; determining success of the prompts based on user inputs responsive to the responses; classifying and ranking the prompts based on the determined success as well as a context associated with each of the prompts; storing the classified prompts in a prompt index; identifying a new prompt and context of the new prompt; prior to the new prompt being transmitted to the one or more machine learning model, causing the generation of an augmented new prompt with content from one or more selected prompts selected from the prompt index, the one or more selected prompts being top-n ranked prompt(s) selected from the prompt index based on the determined success of the one or more selected prompts for a matching context of the one or more selected prompts to the context of the new prompt, such that the top-n ranked prompt(s) having a relatively higher determined success for the matching context will be selected while other prompts with relatively lower determined successes for the matching context will not be selected; causing the augmented new prompt to be transmitted to the one or more machine learning model; obtaining a corresponding model response to the augmented new prompt; and modifying the determined success and/or ranking of the one or more selected prompts in the prompt index based on user input responsive to the model response for the augmented new prompt.
Clause 16. The method of clause 15, wherein the user input responsive to the model response comprises user input for accepting or copying at least a portion of the model response and wherein said modifying includes increasing the determined success and/or ranking of the one or more selected prompts.
Clause 17. The method of clause 15, wherein the user input responsive to the model response comprises user input for rejecting at least a portion of the model response or for responding to the model response with a follow-up prompt and wherein said modifying includes decreasing the determined success and/or ranking of the one or more selected prompts.
Clause 18. The method of clause 15, wherein the generation and transmission of the augmented new prompt is performed without displaying the augmented new prompt.
Clause 19. The method of clause 15, wherein the generation of the augmented new prompt includes displaying the augmented new prompt to a user prior to transmitting the augmented new prompt to the one or more machine learning model.
Clause 20. The method of clause 19, wherein the method further includes receiving user input accepting modification of the new prompt to the augmented new prompt prior to transmitting the augmented new prompt to the one or more machine learning model.

What is claimed:

1. A method for facilitating prompt processing and augmentation, the method comprising:
identifying a new prompt for one or more machine learning model;
prior to transmitting the prompt to the one or more machine learning model, generating an augmented new prompt by augmenting the prompt with content from one or more selected prompts selected from a prompt index, the one or more selected prompts being top-n ranked prompt(s) selected from the prompt index based on a determined success of the one or more selected prompts for a matching context of the one or more selected prompts to a context of the new prompt, such that the top-n ranked prompt(s) having a relatively higher determined success for the matching context will be selected while other prompts with relatively lower determined successes for the matching context will not be selected;
transmitting the augmented new prompt to the one or more machine learning model;
obtaining a corresponding model response to the augmented new prompt; and
identifying user input responsive to the model response and triggering a modification to the determined success and/or ranking of the one or more selected prompts in the prompt index based on the user input responsive to the model response for the augmented new prompt.

2. The method of claim 1, wherein said identifying user input responsive to the model response comprises detecting user input for copying at least a portion of the model response, and wherein said user input results in the determined success and/or ranking of the one or more selected prompts used in the generation of the augmented new prompt to be increased within the prompt index.

3. The method of claim 1, wherein said identifying user input responsive to the model response comprises detecting user input for accepting at least a portion of the model response, and wherein said user input results in the determined success and/or ranking of the one or more selected prompts used in the generation of the augmented new prompt to be increased within the prompt index.

4. The method of claim 1, wherein said identifying user input responsive to the model response comprises detecting user input for rejecting at least a portion of the model response, and wherein said user input results in the determined success and/or ranking of the one or more selected prompts used in the generation of the augmented new prompt to be decreased within the prompt index.

5. The method of claim 1, wherein said identifying user input responsive to the model response comprises detecting user input for responding to the model response with a follow-up prompt, and wherein said user input results in the determined success and/or ranking of the one or more selected prompts used in the generation of the augmented new prompt to be decreased within the prompt index.

6. The method of claim 1, wherein triggering said modification comprises transmitting the user input to a remote computing system managing the prompt index.

7. The method of claim 1, wherein the generation and transmission of the augmented new prompt is performed without displaying the augmented new prompt.

8. The method of claim 1, wherein the generation of the augmented new prompt includes displaying the augmented new prompt to a user prior to transmitting the augmented new prompt to the one or more machine learning model.

9. The method of claim 8, wherein the method further includes receiving user input accepting modification of the new prompt to the augmented new prompt prior to transmitting the augmented new prompt to the one or more machine learning model.

10. A method for facilitating prompt processing and augmentation, the method comprising:
identifying a plurality of prompts processed by one or more machine learning model and corresponding model responses generated for the prompts from the one or more machine learning model;
determining success of the prompts based on user inputs responsive to the responses;
classifying and ranking the prompts based on the determined success as well as a context associated with each of the prompts;
storing the classified prompts in a prompt index;
identifying a new prompt and context of the new prompt;
prior to the new prompt being transmitted to the one or more machine learning model, triggering the generation of an augmented new prompt with content from one or more selected prompts selected from the prompt index, the one or more selected prompts being top-n ranked prompt(s) selected from the prompt index based on the determined success of the one or more selected prompts for a matching context of the one or more selected prompts to the context of the new prompt, such that the top-n ranked prompt(s) having a relatively higher determined success for the matching context will be selected while other prompts with relatively lower determined successes for the matching context will not be selected;
identifying the augmented new prompt that is transmitted to the one or more machine learning model as well as user input responsive to a model response for the augmented new prompt; and
modifying the determined success and/or ranking of the one or more selected prompts in the prompt index based on the user input responsive to the model response for the augmented new prompt.

11. The method of claim 10, wherein the user input responsive to the model response comprises user input for copying at least a portion of the model response and wherein said modifying includes increasing the determined success and/or ranking of the one or more selected prompts.

12. The method of claim 10, wherein the user input responsive to the model response comprises user input for accepting at least a portion of the model response and wherein said modifying includes increasing the determined success and/or ranking of the one or more selected prompts.

13. The method of claim 10, wherein the user input responsive to the model response comprises user input for rejecting at least a portion of the model response and wherein said modifying includes decreasing the determined success and/or ranking of the one or more selected prompts.

14. The method of claim 10, wherein the user input responsive to the model response comprises user input for responding to the model response with a follow-up prompt and wherein said modifying includes decreasing the determined success and/or ranking of the one or more selected prompts.

15. A computing system comprising:
one or more hardware processor; and
one or more hardware storage device having stored computer-executable instructions that are executable by the one or more hardware processor to cause the computing system to implement a method for facilitating prompt processing and augmentation, the method comprising:
identifying a plurality of prompts processed by one or more machine learning model and corresponding model responses generated for the prompts from the one or more machine learning model;
determining success of the prompts based on user inputs responsive to the responses;
classifying and ranking the prompts based on the determined success as well as a context associated with each of the prompts;
storing the classified prompts in a prompt index;
identifying a new prompt and context of the new prompt;
prior to the new prompt being transmitted to the one or more machine learning model, causing the generation of an augmented new prompt with content from one or more selected prompts selected from the prompt index, the one or more selected prompts being top-n ranked prompt(s) selected from the prompt index based on the determined success of the one or more selected prompts for a matching context of the one or more selected prompts to the context of the new prompt, such that the top-n ranked prompt(s) having a relatively higher determined success for the matching context will be selected while other prompts with relatively lower determined successes for the matching context will not be selected;
causing the augmented new prompt to be transmitted to the one or more machine learning model;
obtaining a corresponding model response to the augmented new prompt; and
modifying the determined success and/or ranking of the one or more selected prompts in the prompt index based on user input responsive to the model response for the augmented new prompt.

16. The method of claim 15, wherein the user input responsive to the model response comprises user input for accepting or copying at least a portion of the model response and wherein said modifying includes increasing the determined success and/or ranking of the one or more selected prompts.

17. The method of claim 15, wherein the user input responsive to the model response comprises user input for rejecting at least a portion of the model response or for responding to the model response with a follow-up prompt and wherein said modifying includes decreasing the determined success and/or ranking of the one or more selected prompts.

18. The method of claim 15, wherein the generation and transmission of the augmented new prompt is performed without displaying the augmented new prompt.

19. The method of claim 15, wherein the generation of the augmented new prompt includes displaying the augmented new prompt to a user prior to transmitting the augmented new prompt to the one or more machine learning model.

20. The method of claim 19, wherein the method further includes receiving user input accepting modification of the new prompt to the augmented new prompt prior to transmitting the augmented new prompt to the one or more machine learning model.
